(19) United States
(12) Patent Application Publication
(10) Pub. No.: US 2023/0147159 A1
(43) Pub. Date: May 11, 2023

(54) TIME GAPS FOR SEGMENT-BASED UPLINK TRANSMISSIONS IN NON-TERRESTRIAL NETWORKS

(71) Applicant: QUALCOMM Incorporated, San Diego, CA (US)

(72) Inventors: Ayan SENGUPTA, San Diego, CA (US); Alberto RICO ALVARINO, San Diego, CA (US)

(21) Appl. No.: 17/810,133

(22) Filed: Jun. 30, 2022

Related U.S. Application Data
(60) Provisional application No. 63/278,406, filed on Nov. 11, 2021.

(51) Int. Cl. H04W 72/12; H04W 74/08; H04W 56/00

(52) U.S. Cl. CPC H04W 72/1268; H04W 56/004; H04W 74/0833

(57) ABSTRACT

Certain aspects of the present disclosure provide techniques for communicating segment-based pre-compensated uplink signals in a non-terrestrial network. A method that may be performed the UE includes transmitting capability information indicating whether the UE needs time gaps between transmission segments associated with uplink signals to be transmitted by the UE in a non-terrestrial network (NTN), obtaining, based at least in part on the capability information, configuration information configuring the time gaps between the transmission segments associated with the uplink signals to be transmitted by the UE, and transmitting the uplink signals in one or more transmission segments based on the configuration information.

### CROSS-REFERENCE TO RELATED APPLICATIONS

This application claims benefit of and priority to U.S. Provisional Application No. 63/278,406, filed Nov. 11, 2021, which is hereby assigned to the assignee hereof and hereby expressly incorporated by reference herein in its entirety as if fully set forth below and for all applicable purposes.

### BACKGROUND

### Field of the Disclosure

Aspects of the present disclosure relate to wireless communications, and more particularly, to techniques for communicating segment-based uplink transmissions in non-terrestrial networks (NTNs).

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects can be implemented in a method for wireless communication performed by a user equipment (UE). The method generally includes transmitting capability information indicating whether the UE needs time gaps between transmission segments associated with uplink signals to be transmitted by the UE in a non-terrestrial network (NTN), obtaining, based at least in part on the capability information, configuration information configuring the time gaps between the transmission segments associated with the uplink signals to be transmitted by the UE, and transmitting the uplink signals in one or more transmission segments based on the configuration information.

Certain aspects can be implemented in a method for wireless communication performed by a network entity. The method generally includes receiving capability information from a user equipment (UE) indicating whether the UE needs time gaps between transmission segments associated with uplink signals to be transmitted by the UE in a non-terrestrial network (NTN), transmitting, based on the capability information, configuration information to the UE configuring the time gaps between the transmission segments associated with the uplink signals to be transmitted by the UE, and receiving the uplink signals in one or more transmission segments based on the configuration information.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5A illustrates an example non-terrestrial network.

FIGS. 5B and 5C illustrate different non-terrestrial network architectures.

FIG. 6 is call flow diagram illustrating example operations for communicating segment-based uplink transmissions in non-terrestrial networks.

FIGS. 7-8 illustrate example process flows for communicating segment-based uplink transmissions in non-terrestrial networks.

FIGS. 9 and 10 depict aspects of example communications devices.

### DETAILED DESCRIPTION

Aspects of the present disclosure provide apparatuses, methods, processing systems, and computer-readable mediums for communicating segment-based uplink transmissions in non-terrestrial networks (NTNs).

In some cases, when communicating with a non-terrestrial base station (NTBS) in an NTN, a user equipment (UE) may need to apply uplink pre-compensation to uplink signals transmitted to the NTBS to compensate for changes in propagation delays and Doppler frequency shifts as the NTBS orbits the earth. In some cases, certain uplink signals may be relatively long. During the course of transmitting these uplink signals, the NTBS may move sufficiently far to significantly affect propagation delay and Doppler frequency shift associated with these signals such that any uplink pre-compensation originally applied to these uplink signals is no longer accurate, resulting in at least a portion of these long uplink transmissions not being received by the NTBS. As a result, a UE may be configured with different transmission segments in which to apply different uplink pre-compensation to uplink signals transmitted within these different transmission segments to account for these changes in propagation delays and Doppler frequency shifts as the NTBS moves.

In some cases, applying different uplink pre-compensation to uplink signals in successive transmission segments may require a UE to retune a local oscillator of the UE between these successive transmission segments. However, certain UEs may not be capable of quickly retuning their local oscillators between successive transmission segments. As a result, if these UEs are expected to perform uplink pre-compensation in different manners in successive transmission segments, some uplink signals may not be accurately pre-compensated due to the UE not being able to quickly retune its local oscillator, leading to these uplink signals not being received by an NTBS. Moreover, time and frequency resources within an NTN and power resources at the UE are wasted having to retransmit the uplink signals that were not previously received by the NTBS due to the inaccurate uplink pre-compensation.

Therefore, aspects of the present disclosure provide techniques to allow certain UEs to accurately perform uplink pre-compensation when transmitting uplink signals in an NTN. For example, in some cases, to avoid situations in which certain UEs are not able to quickly retune their local oscillators, the techniques presented herein involve the use of time gaps between transmission segments in which the UE is to apply different uplink pre-composition to uplink signals transmitted within these transmission segments. In some cases, the time gaps may be used by a UE to switch a manner in which it performs uplink pre-compensation (e.g., to retune a frequency of its local oscillator). Accordingly, by using time gaps between transmission segments, the UE may have enough time to switch the manner in which it applies uplink pre-compensation to uplink signals from transmission segment to transmission segment, helping to ensure that these uplink signals are properly received by an NTBS and reducing waste of the time, frequency, and power resources associated with the NTN and UE described above.

### Introduction to Wireless Communication Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

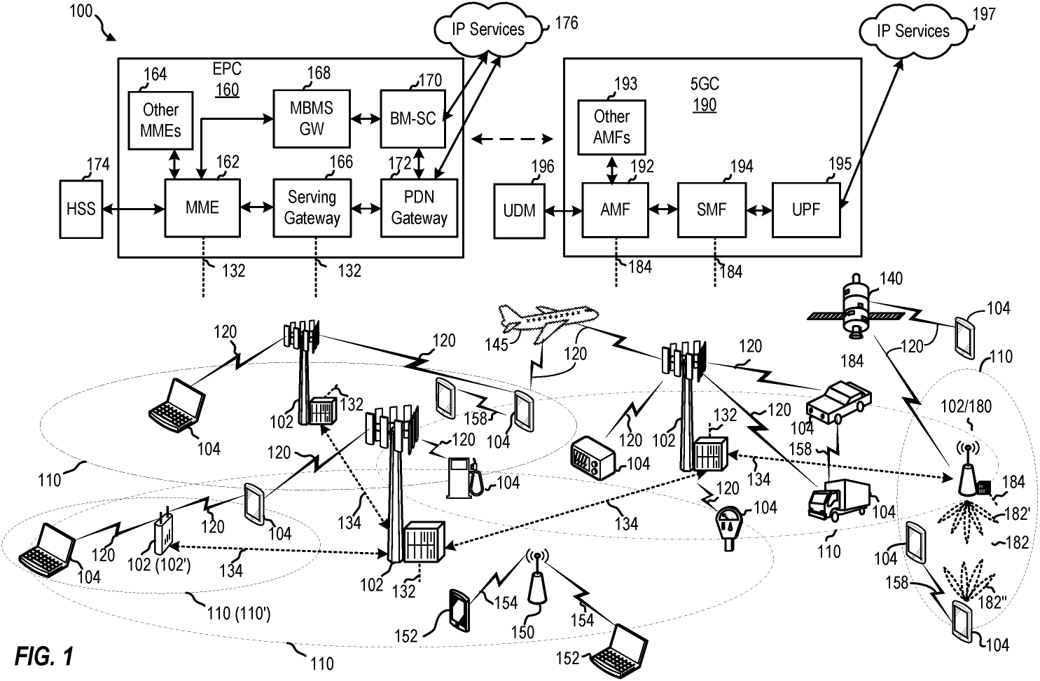

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

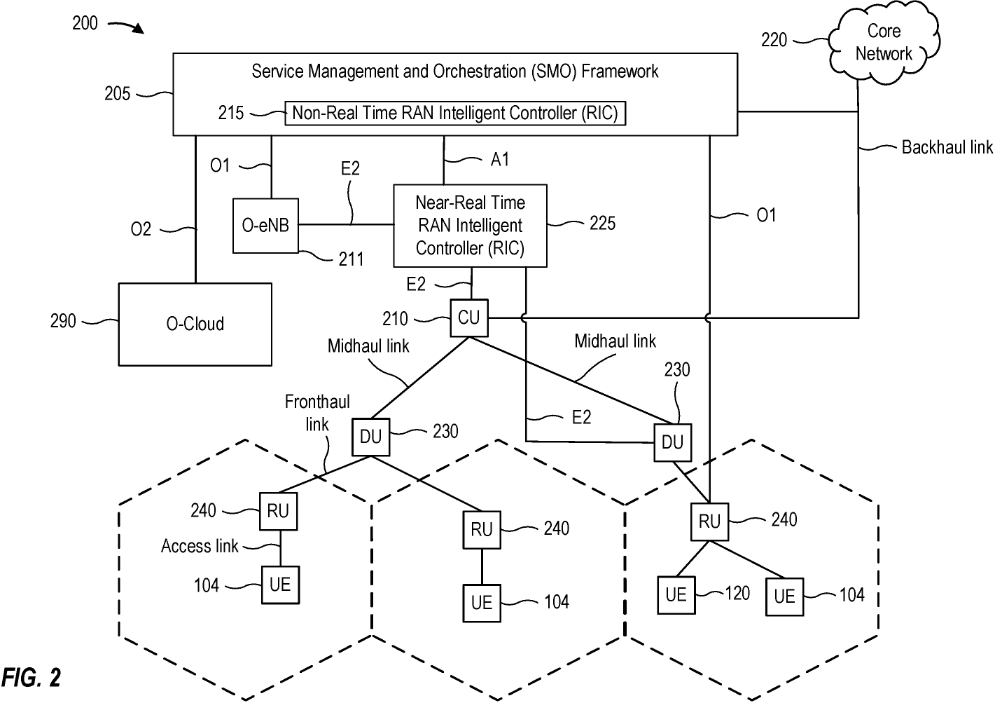

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz - 7125 MHz, which is often referred to (interchangeably) as “Sub-6 GHz”. Similarly, 3GPP currently defines Frequency Range 2 (FR2) as including 24,250 MHz - 52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit - User Plane (CU-UP)), control plane functionality (e.g., Central Unit - Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ Al/ML models to perform corrective actions through the SMO Framework 205 (such as reconfiguration via O1) or via creation of RAN management policies (such as A1 policies).

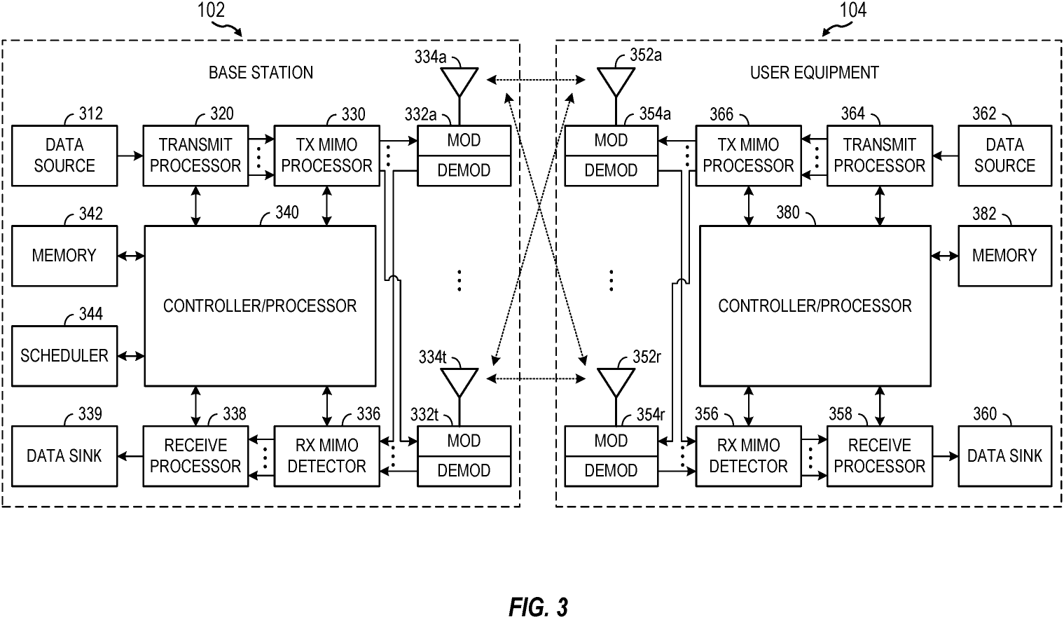

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334at, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

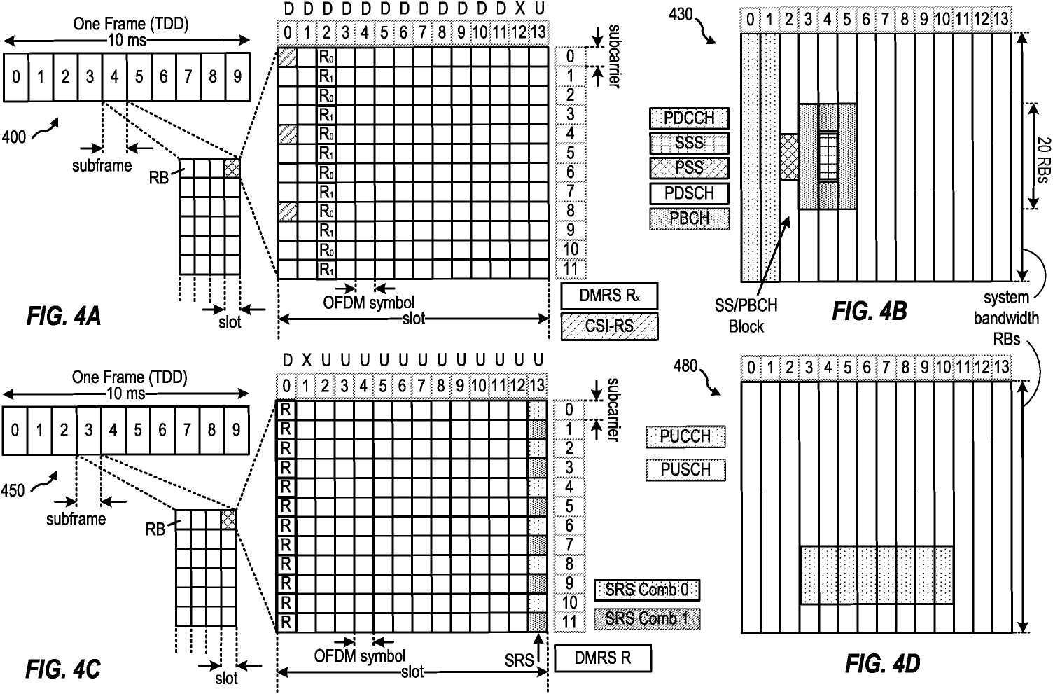

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5GNR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (µ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology µ, there are 14 symbols/slot and 2 µ slots/subframe. The subcarrier spacing and symbol length/duration are a function of the numerology. The subcarrier spacing may be equal to 2^{µ} × 15 kHz, where µ is the numerology 0 to 5. As such, the numerology µ = 0 has a subcarrier spacing of 15 kHz and the numerology µ = 5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology µ = 2 with 4 slots per subframe. The slot duration is 0.25 ms, the subcarrier spacing is 60 kHz, and the symbol duration is approximately 16.67 µs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to Non-Terrestrial Networks

In some cases, communication in a wireless communication network, such as the wireless communication network 100 illustrated in FIG. 1, may be facilitated by one or more non-terrestrial (NT) devices. In such cases, this wireless communication network may be referred to as a NT network (NTN). NT devices may include, for example, devices such as a space satellite (e.g., satellite 140 illustrated in FIG. 1), a balloon, a dirigible, an airplane, a drone, an unmanned aerial vehicle, and/or the like.

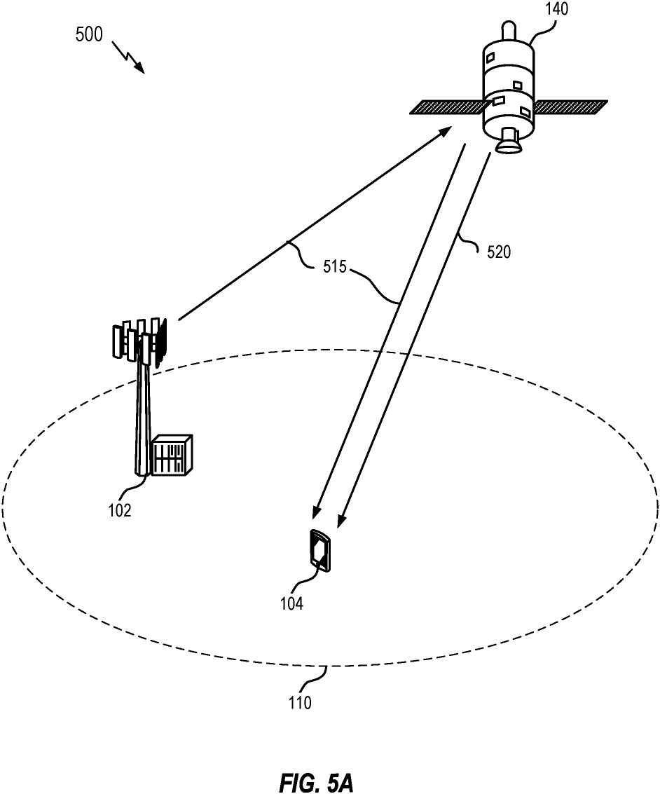

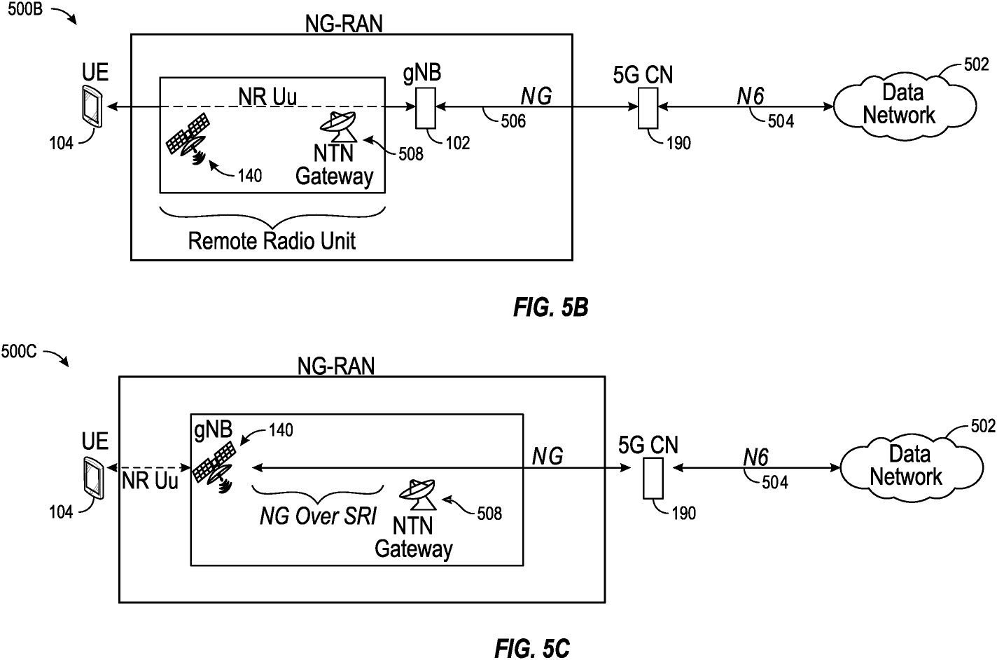

FIG. 5A illustrates an example of an NTN 500A including satellite 140, in which aspects of the present disclosure may be practiced. In some examples, the NTN 500A may implement aspects of the wireless communication network 100. For example, the NTN 500A may include BS 102, UE 104, and satellite 140. BS 102 may serve a coverage area or cell 110 in cases of a terrestrial network, and satellite 140 may serve the coverage area or cell 110 in cases of an NTN. Some NTNs may employ airborne platforms (e.g., a drone or balloon) and/or space borne platforms (e.g., a satellite).

The satellite 140 may communicate with the BS 102 and UE 104 as part of wireless communications in the NTN 500A. In cases of a terrestrial network, the UE 104 may communicate with the BS 102 over a communication link (e.g., communication link 120 in FIG. 1). In the case of NTN wireless communications, the satellite 140 may be the serving cell for the UE 104 via a communication links 520 (e.g., communication link 120 in FIG. 1). In certain aspects, the satellite 140 may act as a relay for the BS 102 and the UE 104, relaying both data transmission and control signaling 515.

The UE 104 may determine to connect to the satellite 140 using a random access (RA) procedure (e.g., a four-step RA procedure or a two-step RA procedure). The initiation of the RA procedure may begin with the transmission of a RA preamble (e.g., an NR preamble for RA) by the UE 104 to the satellite 140 or BS 102. The UE 104 may transmit the RA preamble on a physical random access channel (PRACH). In some PRACH designs, there may be no estimation or accounting for the RTD or the frequency shift associated with NTNs. In certain networks, such as terrestrial NR networks (e.g., 5G NR), SSBs transmitted by a cell are transmitted on the same frequency interval (e.g., occupying the same frequency interval). In NTN, a satellite may use multiple antennas to form multiple narrow beams and the beams may operate on different frequency intervals to mitigate interference among the beams.

In some cases, different architectures may exist for NTNs, such as a transparent satellite based NTN architecture and a regenerative satellite based NTN architecture. An example of the transparent satellite based NTN architecture is illustrated in FIG. 5B while an example of the regenerative satellite based NTN architecture is illustrated in FIG. 5C. In some cases, the NTN architectures shown in FIGS. 5B and 5C may be implemented in the NTN 500A shown in FIG. 5A.

In general, the transparent satellite based NTN architecture (e.g., also known as a bent-pipe satellite architecture, such as depicted in FIG. 5B) involves the satellite 140 receiving a signal from a BS 102 and relaying the signal to a UE 104 or another BS 102, or vice-versa. In the regenerative satellite based NTN architecture (such as depicted in FIG. 5C), satellite 140 may be configured to relay signals like the bent-pipe transponder or satellite, but may also use on-board processing to perform other functions, such as demodulating a received signal, decoding a received signal, re-encoding a signal to be transmitted, or modulating the signal to be transmitted, or a combination thereof.

For example, as shown in FIG. 5B, in a transparent satellite based NTN architecture 500B, communication between a UE 104 and a data network (DN) 502 may begin with data being sent from the DN 502 over a communication link 504 to user plane function (UPF) in a 5G core network (5G CN), such as the UPF 195 in 5GC 190 illustrated in FIG. 1. In some cases, the communication link 504 between the DN 502 and the UPF in the 5GC 190 may be associated with an N6 interface. Thereafter, the data may be forwarded from the 5GC 190 to BS 102 via a communication link 506 associated with an NG interface. The data may then be sent by the BS 102 to the UE 104 on a new radio (NR) Uu interface via an NTN gateway 508 and satellite 140. For example, the NTN gateway 508 may receive the data from the BS 102 and may forward the data to the satellite 140 on a feeder link via a satellite radio interface (SRI). The SRI on the feeder link is the NR Uu interface. Thereafter, the satellite 140 may perform radio frequency filtering, frequency conversion, and amplification on the received data before relaying the data to the UE 104 on a service link. Hence, the satellite 140 in the transparent satellite based NTN architecture 500B merely repeats the data on the NR-Uu radio interface from the feeder link (e.g., between the NTN gateway 508 and the satellite 140) to the service link (e.g., between the satellite 140 and the UE 104) and vice versa. In other words, the data is un-changed by the satellite 140 and is simply relayed to the UE 104.

In the regenerative satellite based NTN architecture 500C illustrated in FIG. 5C, the data from the DN 502 may be sent from the 5G CN directly to the satellite 140 via NTN gateway 508 without first being processed by BS 102. For example, the NTN gateway 508 may send the data to the satellite 140 on a feeder link that implements an SRI interface. After receiving the data, the satellite 140 may perform radio frequency filtering, frequency conversion and amplification as well as demodulation/decoding, switch and/or routing, coding/modulation. This is effectively equivalent to having all or part of BS 102 functions (e.g. gNB) on board the satellite 140. Thereafter, the satellite 140 transmits the data to the UE 104 on an NR-Uu radio interface via a service link between the UE 104 and the satellite 140.

### Aspects Related to Communicating Segment-Based Pre-Compensated Uplink Signals in Non-Terrestrial Networks

As discussed above, wireless communications may be performed in a non-terrestrial network (NTN) (e.g., NTN 500A) between non-terrestrial base stations (NTBSs) (e.g., satellite 140) and other wireless communication devices, such as user equipments (UEs) (e.g., UE 104). Within an NTN, these NTBSs may orbit Earth in geostatic orbits and non-geostatic orbits. NTBSs with a geostatic orbit may have a position in space that is static relative to a fixed position on earth while NTBSs with non-geostatic orbits may have positions that are non-static relative to the fixed position on Earth. In other words, NTBSs in non-geostatic orbit may move with high speed relative to a fixed position on Earth.

During communication, uplink signals transmitted by a UE may have a certain propagation delay before begin received by an NTBS. This propagation delay is the amount of time it takes for an uplink signal transmitted by the UE to travel from the UE to the NTBS. Because a non-geostatic NTBS moves at high speed relative to a fixed position on earth, the propagation delay of an uplink signal transmitted from the UE to the NTBS changes over time.

Moreover, due to the high speed of the NTBS, the NTBS may observe a Doppler frequency shift when receiving uplink signals from the UE, which may also change over time. For example, in some cases, when the NTBS is moving towards the UE, a frequency of the uplink signals received by the UE may be increased (e.g., relative to an actual transmission frequency of the uplink signals) while, when the NTBS is moving away from the UE, the frequency of the uplink signals received by the NTBS may be decreased (e.g., relative to the actual transmission frequency of the uplink signals).

These changes in propagation delay and Doppler frequency shifts may, in some cases, prevent the NTBS from receiving the uplink signals transmitted from the UE. For example, the changes in the propagation delay associated with signals transmitted by the UE may result in the signals arriving at a different time than expected by the NTBS while changes in the Doppler frequency shift may result in the uplink signals arriving at a different frequency then expected by the NTBS.

Accordingly, to help reduce the changes in propagation delay and Doppler frequency shift associated with uplink signals, the UE may use a technique known as uplink pre-compensation. Uplink pre-compensation may, in some cases, involve the UE adjusting a particular frequency of a local oscillator or digital baseband frequency of the UE used to transmit the uplink signals to accurately compensate for Doppler frequency shifts and to ensure that the uplink signals are received by the NTBS at an expected frequency. Additionally, in some cases, the UE may adjust a transmission time associated with the uplink transmissions to accurately compensate for propagation delays and to ensure that the uplink signals are received by the NTBS at an expected time. In some cases, the uplink pre-compensation applied by the UE may depend on a geolocation of the NTBS (as well as the UE) and a velocity of the NTBS.

Uplink pre-compensation functions well for short uplink transmissions as the propagation delay and Doppler frequency shift may be relatively constant during the transmission of these uplink transmissions. However, for “long” uplink transmissions, such slot-aggregated transmissions or a transmission with multiple repetitions (e.g., enhanced machine type communication (eMTC) transmissions and/or narrow band internet of things (NB-IoT) transmissions), during the course of transmitting these long uplink transmissions, the NTBS may move sufficiently far to significantly affect propagation delay and Doppler frequency shift associated with these signals such that any uplink pre-compensation originally applied to these uplink signals may no longer be accurate, resulting in at least a portion of these long uplink transmissions not being received properly by the NTBS.

To help account for the situation described above (e.g., in which uplink pre-composition applied by a UE is no longer accurate), the UE may be configured to apply uplink pre-compensation differently in different transmission segments in which the UE is scheduled to transmit uplink signals. In some cases, a transmission segment comprises a period of time in which the UE is to apply uplink pre-compensation in a particular manner to uplink signals occurring within the transmission segment/period of time to compensate for propagation delay and Doppler frequency shift associated with an NTBSs geolocation and velocity. For example, in some cases, the UE may apply uplink pre-compensation to uplink signals transmitted in a first transmission segment in a first manner to account for propagation delay and Doppler frequency shift associated with the NTBS at a first time and first geolocation. The UE may then apply the uplink pre-compensation to uplink signals transmitted in a second transmission segment in a second manner to account for propagation delay and Doppler frequency shift associated with the NTBS at a second time and second geolocation.

In some cases, however, certain UEs (e.g., low cost, low complexity UEs) may not be able to immediately switch the manners in which uplink pre-compensation is applied between successive transmission segments. For example, as noted above, applying uplink pre-compensation may involve tuning a local oscillator to a particular frequency to account for a particular Doppler frequency shift. However, certain UEs may not be capable of quickly retuning their local oscillators between successive transmission segments. As a result, if these UEs are expected to perform uplink pre-compensation in different manners in successive transmission segments, some uplink signals may not be accurately pre-compensated due to the UE not being able to quickly retune its local oscillator, leading to these uplink signals not being received properly by an NTBS. Moreover, time and frequency resources within an NTN and power resources at the UE may be wasted having to retransmit the uplink signals that were not properly received by the NTBS due to the inaccurate uplink pre-compensation.

Therefore, aspects of the present disclosure provide techniques to allow certain UEs to accurately perform uplink pre-compensation when transmitting uplink signals in an NTN. For example, in some cases, to avoid situations in which certain UEs are not able to quickly retune their local oscillators, the techniques presented herein involve the use of time gaps between transmission segments in which the UE is to apply different uplink pre-composition to uplink signals transmitted within these transmission segments. In some cases, the time gaps may be used by a UE to switch a manner in which it performs uplink pre-compensation (e.g., to retune a frequency of its local oscillator). Accordingly, by using time gaps between transmission segments, the UE may have enough time to switch the manner in which it applies uplink pre-compensation to uplink signals from transmission segment to transmission segment, helping to ensure that these uplink signals are properly received by an NTBS and, thereby, reducing waste of the time, frequency, and power resources associated with the NTN and UE described above.

### Example Call Flow Illustrating Operations for Communicating Segment-Based Pre-Compensated Uplink Signals in Non-Terrestrial Networks

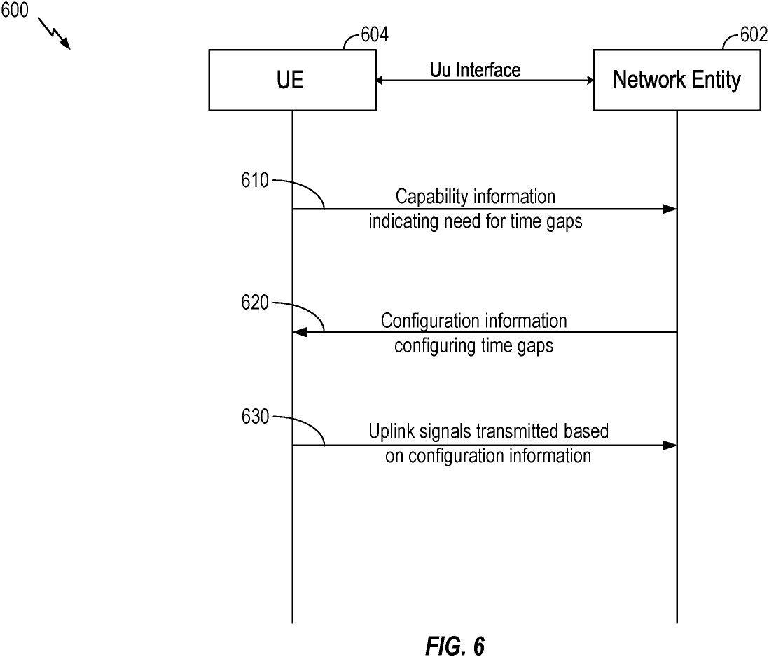

FIG. 6 is a call flow diagram illustrating example operations 600 between a network entity 602 and a UE 604 for communicating uplink signals in one or more transmission segments in an NTN. In some cases, the network entity 602 may comprise an NTBS in the NTN (e.g., NTN 500A illustrated in FIGS. 4 and 6), such as satellite 140 illustrated in FIGS. 1, and 5A-5C. In other cases, the network entity 602 may be an example of the BS 102 illustrated in FIGS. 1 and 3 and/or a disaggregated BS as described with respect to FIG. 2. Additionally, the UE 604 may be an example of the UE 104 illustrated in FIGS. 1, 3, and 5A-5C. Further, as shown, a Uu interface may be established to facilitate communication between the network entity 602 and UE 604, however, in other aspects, a different type of interface may be used.

As shown in FIG. 6, operations 600 begin at 610 with the UE 604 transmitting capability information to the network entity 602. In some cases, the capability information may indicate whether the UE 604 needs time gaps between transmission segments associated with uplink signals to be transmitted by the UE. For example, in some cases, the UE may provide an indication within the capability information, such as “Need_inter-segment_gaps_NTN,” which may be interpreted by the network entity 602 that the UE 604 needs time gaps between successive transmission segments. In some cases, UEs that do not provide this indication within capability information may be interpreted by the network entity 602 as not needing the time gaps between successive transmission segments (at least for non-default channels, as explained below). In some cases, the uplink signals may be associated with an NB-IoT service in the NTN or an eMTC service in the NTN.

In some cases, the UE 604 may indicate the need for these time gaps for only certain channels over which the uplink signals are transmitted. In other words, the capability information transmitted by the UE 604 at 610 in FIG. 6 indicates one or more channels for which the time gaps are needed and via which the uplink signals are to be transmitted. For example, in some cases, the UE 604 may indicate that the time gaps are needed for uplink signals transmitted on a physical uplink shared channel (PUSCH).

Thereafter, the UE 604 obtains configuration information based at least in part on the capability information transmitted at 610. In some cases, the configuration information includes information configuring the time gaps between the transmission segments associated with the uplink signals to be transmitted by the UE 604. In some cases, as shown at 620, obtaining the configuration information comprises receiving the configuration information from the network entity 602 in response to transmitting the capability information to the network entity 602. In some cases, the configuration information may be pre-configured in the UE 604 based on a standards document. For example, in some cases, the configuration information may be stored in memory of the UE 604 during a manufacturing process or provisioning process of the UE 604 by an original equipment manufacturer (OEM) of the UE 604.

In some cases, the configured time gaps may apply only to certain channels. More specifically, in some cases, the time gaps may be configured by the configuration information for the uplink signals to be transmitted via one or more first channels while not configured for the uplink signals to be transmitted via one or more second channels. For example, in some cases, the one or more first channels comprise at least a physical uplink shared channel (PUSCH) (e.g., a narrow band PUSCH) and the one or more second channels comprise at least a physical random access channel (PRACH) (e.g., a narrow band PRACH).

In some cases, the configured time gaps may apply only to certain connection states associated with the UE 604. More specifically, in some cases, the time gaps may be configured by the configuration information for the uplink signals to be transmitted during a first connection state of the UE 604 and not configured for the uplink signals to be transmitted during a second connection state of the UE 604. For example, in some cases, the first connection state comprises a radio resource control (RRC) connected state and the second connection state comprises a non-RRC connected state.

In some cases, the configuration information includes a duration for the time gaps between the transmission segments associated with the uplink signals to be transmitted by the UE 604. In some cases, the duration for the time gaps may depend on a subcarrier spacing (SCS) associated with the uplink signals. For example, in some cases, for a first subcarrier spacing (e.g., a 15 kilohertz (kHz) SCS), the duration for the time gaps comprises a first duration (e.g., 1 millisecond (ms)) while, for a second subcarrier spacing that is less than the first subcarrier spacing (e.g., a 3.75 kHz SCS), the duration for the time gaps comprises a second duration that is greater than the first duration (e.g., 2 ms).

Thereafter, as illustrated at 630 in FIG. 6, the UE 604 transmits the uplink signals in one or more transmission segments based on the configuration information. In some cases, transmitting the uplink signals in the one or more transmission segments may include applying uplink pre-compensation to the uplink signals in different transmission segments in different manners to account for different propagation delays and frequency shifts associated with the network entity 602.

More specifically, for example, in some cases, the UE 604 may compensate for at least one of a first propagation delay and a first frequency shift for a first set of uplink signals of the uplink signals to be transmitted in a first transmission segment of the one or more transmission segments. Thereafter, the UE 604 may compensate for at least one of a second propagation delay and a second frequency shift for a second set of uplink signals of the uplink signals to be transmitted in a second transmission segment of the one or more transmission segments.

In some cases, compensating for the first frequency shift for the first set of uplink signals may include tuning a local oscillator of the UE 604 to a first frequency to account for the first frequency shift. Thereafter, the UE 604 may transmit the first set of uplink signals in the first transmission segment based on the first frequency of the local oscillator of the UE 604, which compensates for the first frequency shift and allows the first set of uplink signals to be properly received by the network entity 602.

In other cases, compensating for the first frequency shift for the first set of uplink signals may include adjusting a digital baseband frequency of the UE 604 to account for the first frequency shift. In some cases, compensating for the first propagation delay for the first set of uplink signals may include adjusting a transmission time for the first set of uplink signals to account for the first propagation delay. Accordingly, the UE 604 may transmit the first set of uplink signals the first transmission segment according to the adjusted digital baseband signal and/or adjusted transmission time to account for the first propagation delay and/or the first frequency shift.

In some cases, to compensate for the second frequency shift for the second set of uplink signals, the UE 604 may retune the local oscillator of the UE 604 to a second frequency accounting for the second frequency shift. In some cases, the UE 604 may perform the retuning of the local oscillator during a time gap between the first transmission segment and the second transmission segment. In other words, the time gap between the first transmission segment and the second transmission segment may afford the UE 604 enough time to perform the retuning of the local oscillator to ensure that the uplink signals transmitted in the second transmission segment are properly transmitted (e.g., so that the uplink signals can be properly received by the network entity 602). Thereafter, the UE 604 may transmit the second set of uplink signals in the second transmission segment based on the second frequency of the local oscillator of the UE 604, which compensates for the second propagation delay and/or the second frequency shift and allows the second set of uplink signals to be properly received by the network entity 602.

In other cases, compensating for the second frequency shift for the second set of uplink signals may include adjusting the digital baseband frequency of the UE 604 to account for the second frequency shift. In some cases, compensating for the second propagation delay for the second set of uplink signals may include adjusting the transmission time for the second set of uplink signals to account for the second propagation delay. Accordingly, the UE 604 may transmit the second set of uplink signals in the second transmission segment according to the adjusted digital baseband signal and/or adjusted transmission time to account for the second propagation delay and/or the second frequency shift.

In some cases, when using time gaps between transmission segments, there may be instances when a portion of the uplink signals to be transmitted by the UE 604 occur within a time gap between two transmission segments. For example, in some cases, a portion of the uplink signals transmitted at 630 in FIG. 6 may be scheduled by the network entity 602 to be transmitted by the UE 604 during a first time gap between a first transmission segment of the one or more transmission segments and a second transmission segment of the one or more transmission segments. In such cases, the UE 604 may drop transmission of the portion of the uplink signals scheduled to be transmitted during the first time gap. In other words, the UE 604 may decide to not transmit the portion of the uplink signals scheduled to be transmitted during the first time gap.

In other cases, rather than schedule the portion of uplink signals in the first time gap between the first transmission segment and the second transmission segment, the network entity 602 may instead postpone the uplink signals scheduled in the first time gap and instead schedule them in the second transmission segment or a transmission segment occurring after the second transmission segment. In other words, no portion of the uplink signals may be scheduled by the network entity 602 for transmission within any time gap between any transmission segments of the one or more transmission segments.

In some cases, there may be instances in which time gaps may be configured for all UEs, regardless of whether certain UEs need the time gaps or not. More specifically, the time gaps may be configured by the configuration information by default for the uplink signals transmitted by the UE via one or more default channels during a random access procedure regardless of the capability information indicating whether the UE needs the time gaps between the transmission segments. In some cases, the one or more default channels comprise a PRACH and a PUSCH. Accordingly, in this case, the uplink signals include at least one of a message to be transmitted on the PRACH during the random access procedure (e.g., Msg1 or MsgA) or a message to be transmitted on the PUSCH during the random access procedure (Msg3). In other words, the time gaps may be configured by default for Msg1 or MsgA transmitted on PRACH during the random access procedure and/or Msg3 transmitted on the PUSCH during the random access procedure.

Further, in some cases, the capability information transmitted in FIG. 6 at 610 by the UE 604 may indicate that the UE 604 does not need the time gaps between the transmission segments associated with uplink signals to be transmitted by the UE 604. The UE 604 may, in this case, be a more complex UE that is capable of quickly switching the manner in which uplink pre-compensation is performed between successive transmission segments. In such cases, based on the indication that the UE 604 does not need the time gaps, the configuration information obtained by the UE 604 (e.g., whether it be received from the network entity 602 or preconfigured) does not configure the UE 604 with the time gaps for channels other than the default channels. In other words, when the UE 604 does not need the time gaps, the UE 604 may not expect to be configured with the time gaps for any channels except for the default channels.

Additionally, because these time gaps may be configured by default for all UEs for the uplink signals on the default channels, in some cases, the duration for these time gaps may be dependent on the SCS of the uplink signals, regardless of whether particular UEs need the time gaps or not. Similarly, in some cases, when a portion of these uplink signals occur within a time gap, all UEs may decide whether to drop this portion of uplink signals or the network entity 602 may simply not schedule the uplink transmissions during the time gap, as described above, regardless of whether particular UEs need the time gaps or not. In other cases, for particular UEs that do not need the time gaps, these UEs may decide whether or not to use the SCS-dependent time gap duration and/or the dropping/delaying of uplink transmissions that occur during time gaps. In other words, the SCS-dependent time gap delay and dropping of uplink transmissions that occur within time gaps may not be necessary for UEs that do not need the time gaps.

### Example Operations of a Network Entity

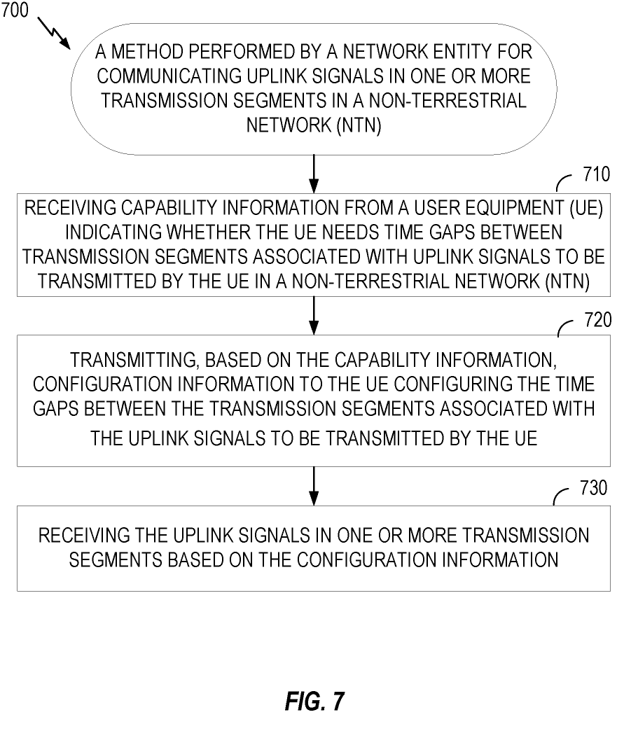

FIG. 7 shows a method 700 for wireless communications by a network entity, such as satellite 140 or BS 102 illustrated in FIGS. 1, 3, 5A-5C, and 6 and/or a disaggregated base station as described with respect to FIG. 2.

Method 700 begins in step 710 with receiving capability information from a UE indicating whether the UE needs time gaps between transmission segments associated with uplink signals to be transmitted by the UE in an NTN.

In step 720, the network entity transmits, based on the capability information, configuration information to the UE configuring the time gaps between the transmission segments associated with the uplink signals to be transmitted by the UE.

In step 730, the network entity receives the uplink signals in one or more transmission segments based on the configuration information

In some cases, the time gaps are configured by the configuration information for the uplink signals transmitted via one or more first channels and are not configured for the uplink signals transmitted via one or more second channels.

In some cases, the one or more first channels comprise at least a PUSCH and the one or more second channels comprise at least a PRACH.

In some cases, the capability information indicates one or more channels for which the time gaps are needed.

In some cases, the time gaps are configured by the configuration information for the uplink signals to be transmitted during a first connection state of the UE and are not configured for the uplink signals to be transmitted during a second connection state of the UE.

In some cases, the first connection state comprises an RRC connected state and the second connection state comprises a non-RRC connected state.

In some cases, the configuration information includes a duration for the time gaps between the transmission segments associated with the uplink signals to be transmitted by the UE.

In some cases, the duration for the time gaps depends on a subcarrier spacing associated with the uplink signals.

In some cases, for a first subcarrier spacing, the duration for the time gaps comprises a first duration. Additionally, in some cases, for a second subcarrier spacing that is less than the first subcarrier spacing, the duration for the time gaps comprises a second duration that is greater than the first duration.

In some cases, a portion of the uplink signals are scheduled to be transmitted by the UE during a first time gap between a first transmission segment of the one or more transmission segments and a second transmission segment of the one or more transmission segments. Additionally, in some cases, method 700 may further include not receiving the portion of the uplink signals scheduled to be transmitted during the first time gap.

In some cases, no portion of the uplink signals are scheduled for transmission within any time gap between any transmission segments of the one or more transmission segments.

In some cases, the time gaps are configured by default for the uplink signals transmitted by the UE via one or more default channels during a random access procedure regardless of the capability information indicating whether the UE needs the time gaps between the transmission segments.

In some cases, the one or more default channels comprise a PRACH and a PUSCH. Additionally, in some cases, the uplink signals include at least one of a message to be transmitted on the PRACH during the random access procedure or a message to be transmitted on the PUSCH during the random access procedure.

In some cases, the capability information indicates the UE does not need the time gaps between the transmission segments associated with uplink signals to be transmitted by the UE. Additionally, in some cases, based on the indication that the UE does not need the time gaps, the configuration information does not configure the UE with the time gaps for channels other than the default channels.

In some cases, the uplink signals are associated with an NB-IoT) service in the NTN or an eMTC service in the NTN.

In one aspect, method 700, or any aspect related to it, may be performed by an apparatus, such as communications device 1000 of FIG. 10, which includes various components operable, configured, or adapted to perform the method 700. Communications device 1000 is described below in further detail.

Note that FIG. 7 is just one example of a method, and other methods including fewer, additional, or alternative steps are possible consistent with this disclosure.

### Example Operations of a User Equipment

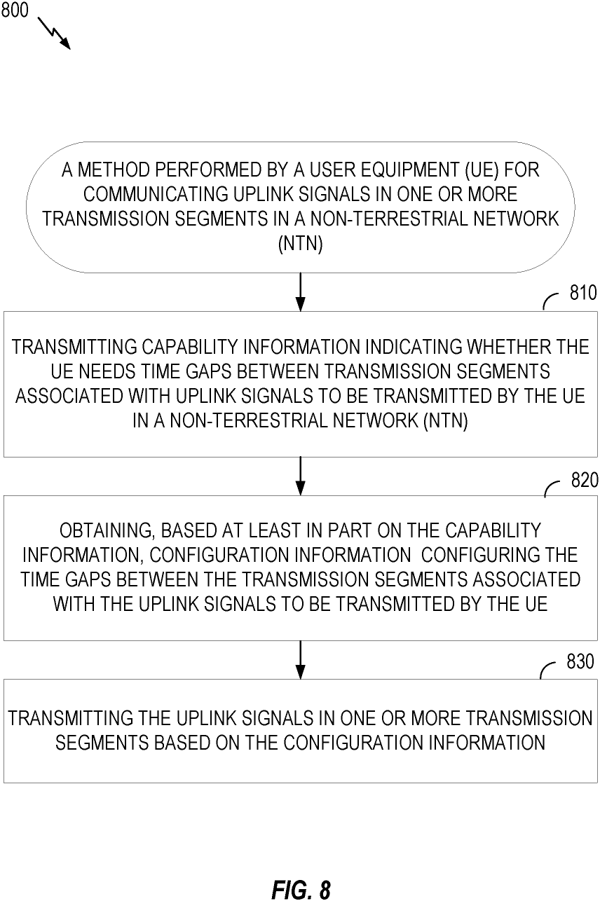

FIG. 8 shows a method 800 for wireless communications by a UE, such as UE 104 of FIGS. 1 and 3.

Method 800 begins in step 810 with the UE transmitting capability information indicating whether the UE needs time gaps between transmission segments associated with uplink signals to be transmitted by the UE in an NTN.

In step 820, the UE obtains, based at least in part on the capability information, configuration information configuring the time gaps between the transmission segments associated with the uplink signals to be transmitted by the UE.

In step 830, the UE transmits the uplink signals in one or more transmission segments based on the configuration information.

In some cases, obtaining the configuration information comprises receiving the configuration information from a network entity in the NTN in response to transmitting the capability information to the network entity.

In some cases, the configuration information is preconfigured in the UE based on a standards document.

In some cases, the time gaps are configured by the configuration information for the uplink signals transmitted via one or more first channels and are not configured for the uplink signals transmitted via one or more second channels.

In some cases, wherein the one or more first channels comprise at least a PUSCH and the one or more second channels comprise at least a PRACH.

In some cases, the capability information indicates one or more channels for which the time gaps are needed.

In some cases, the time gaps are configured by the configuration information for the uplink signals to be transmitted during a first connection state of the UE and are not configured for the uplink signals to be transmitted during a second connection state of the UE.

In some cases, the first connection state comprises an RRC connected state and the second connection state comprises a non-RRC connected state.

In some cases, the configuration information includes a duration for the time gaps between the transmission segments associated with the uplink signals to be transmitted by the UE.

In some cases, the duration for the time gaps depends on a subcarrier spacing associated with the uplink signals.

In some cases, for a first subcarrier spacing, the duration for the time gaps comprises a first duration. Additionally, in some cases, for a second subcarrier spacing that is less than the first subcarrier spacing, the duration for the time gaps comprises a second duration that is greater than the first duration.

In some cases, a portion of the uplink signals are scheduled to be transmitted by the UE during a first time gap between a first transmission segment of the one or more transmission segments and a second transmission segment of the one or more transmission segments. Additionally, in some cases, method 800 further include dropping transmission of the portion of the uplink signals scheduled to be transmitted during the first time gap.

In some cases, no portion of the uplink signals are scheduled for transmission within any time gap between any transmission segments of the one or more transmission segments.

In some cases, the time gaps are configured by the configuration information by default for the uplink signals transmitted by the UE via one or more default channels during a random access procedure regardless of the capability information indicating whether the UE needs the time gaps between the transmission segments.

In some cases, the one or more default channels comprise a PRACH and a PUSCH. Additionally, in some cases, the uplink signals include at least one of a message to be transmitted on the PRACH during the random access procedure or a message to be transmitted on the PUSCH during the random access procedure.

In some cases, the capability information indicates the UE does not need the time gaps between the transmission segments associated with uplink signals to be transmitted by the UE. Additionally, in some cases, based on the indication that the UE does not need the time gaps, the configuration information does not configure the UE with the time gaps for channels other than the default channels.

In some cases, the uplink signals are associated with an NB-IoT service in the NTN or an eMTC service in the NTN.

In some cases, transmitting the uplink signals in the one or more transmission segments comprises compensating for a first propagation delay and a first frequency shift for a first set of uplink signals of the uplink signals to be transmitted in a first transmission segment of the one or more transmission segments. Additionally, in some cases, transmitting the uplink signals in the one or more transmission segments comprises compensating for a second propagation delay and second frequency shift for a second set of uplink signals of the uplink signals to be transmitted in a second transmission segment of the one or more transmission segments, to a second frequency account for the second propagation delay and second frequency shift.

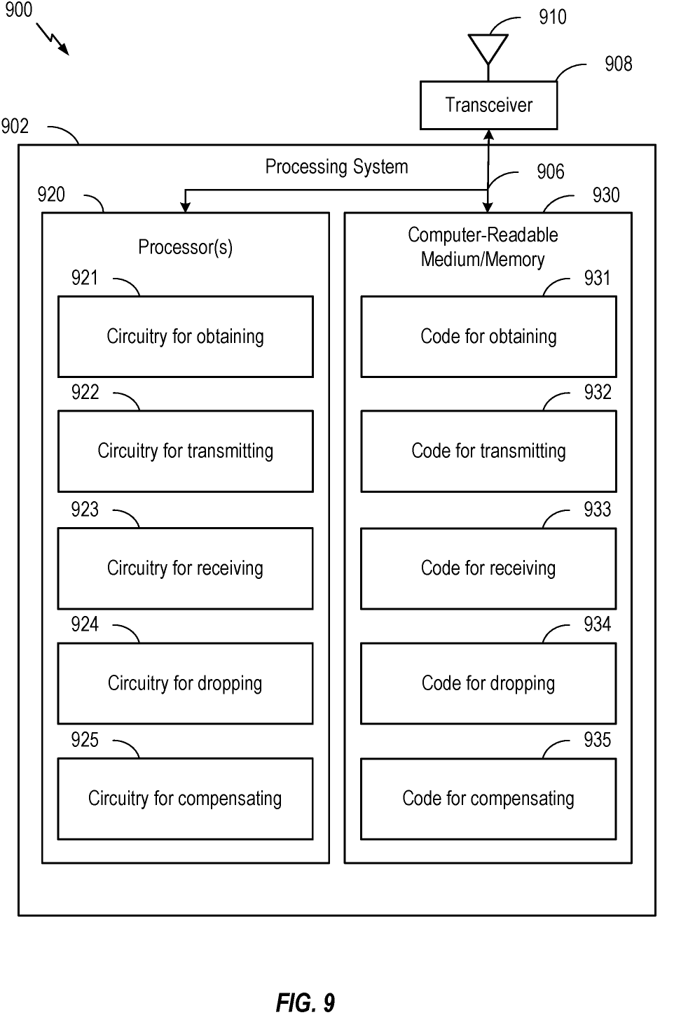

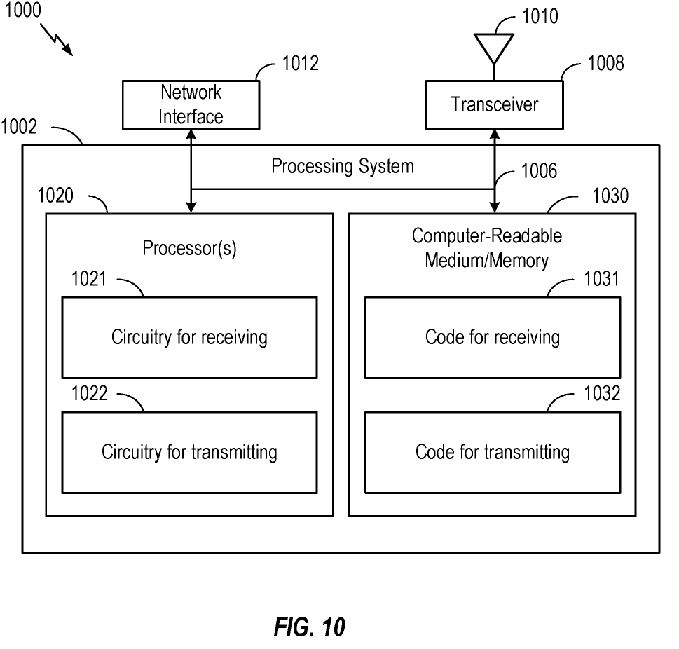

In one aspect, method 800, or any aspect related to it, may be performed by an apparatus, such as communications device 900 of FIG. 9, which includes various components operable, configured, or adapted to perform the method 800. Communications device 900 is described below in further detail.

Note that FIG. 8 is just one example of a method, and other methods including fewer, additional, or alternative steps are possible consistent with this disclosure.

### Example Communications Devices

FIG. 9 depicts aspects of an example communications device 900. In some aspects, communications device 900 is a user equipment, such as UE 104 described above with respect to FIGS. 1 and 3.

The communications device 900 includes a processing system 902 coupled to a transceiver 908 (e.g., a transmitter and/or a receiver). The transceiver 908 is configured to transmit and receive signals for the communications device 900 via an antenna 910, such as the various signals as described herein. The processing system 902 may be configured to perform processing functions for the communications device 900, including processing signals received and/or to be transmitted by the communications device 900.

The processing system 902 includes one or more processors 920. In various aspects, the one or more processors 920 may be representative of one or more of receive processor 358, transmit processor 364, TX MIMO processor 366, and/or controller/processor 380, as described with respect to FIG. 3. The one or more processors 920 are coupled to a computer-readable medium/memory 930 via a bus 906. In certain aspects, the computer-readable medium/memory 930 is configured to store instructions (e.g., computer-executable code) that when executed by the one or more processors 920, cause the one or more processors 920 to perform the method 800 described with respect to FIG. 8, or any aspect related to it. Note that reference to a processor performing a function of communications device 900 may include one or more processors performing that function of communications device 900.

In the depicted example, computer-readable medium/memory 930 stores code (e.g., executable instructions) for obtaining 931, code for transmitting 932, code for receiving 933, code for dropping 934, and code for compensating 935. Processing of the code 931-935 may cause the communications device 900 to perform the method 800 described with respect to FIG. 8, or any aspect related to it.

The one or more processors 920 include circuitry configured to implement (e.g., execute) the code stored in the computer-readable medium/memory 930, including circuitry for obtaining 921, circuitry for transmitting 922, circuitry for receiving 923, circuitry for dropping 924, and circuitry for compensating 925. Processing with circuitry 921-925 may cause the communications device 900 to perform the method 800 described with respect to FIG. 8, or any aspect related to it.

Various components of the communications device 900 may provide means for performing the method 800 described with respect to FIG. 8, or any aspect related to it. For example, means for transmitting, sending or outputting for transmission may include the transceivers 354 and/or antenna(s) 352 of the UE 104 illustrated in FIG. 3 and/or transceiver 908 and antenna 910 of the communications device 900 in FIG. 9. Means for receiving or obtaining may include the transceivers 354 and/or antenna(s) 352 of the UE 104 illustrated in FIG. 3 and/or transceiver 908 and antenna 910 of the communications device 900 in FIG. 9. Additionally, means for dropping and means for compensating may include one or more processors, such as the controller/processor 380 or transmit processor 364 of the UE 104 illustrated in FIG. 3 and/or processor(s) 920 of the communications device 900 in FIG. 9.

FIG. 10 depicts aspects of an example communications device. In some aspects, communications device 1000 is a network entity, such as BS 102 of FIGS. 1 and 3, or a disaggregated base station as discussed with respect to FIG. 2.

The communications device 1000 includes a processing system 1002 coupled to a transceiver 1008 (e.g., a transmitter and/or a receiver) and/or a network interface 1012. The transceiver 1008 is configured to transmit and receive signals for the communications device 1000 via an antenna 1010, such as the various signals as described herein. The network interface 1012 is configured to obtain and send signals for the communications device 1000 via communications link(s), such as a backhaul link, midhaul link, and/or fronthaul link as described herein, such as with respect to FIG. 2. The processing system 1002 may be configured to perform processing functions for the communications device 1000, including processing signals received and/or to be transmitted by the communications device 1000.

The processing system 1002 includes one or more processors 1020. In various aspects, one or more processors 1020 may be representative of one or more of receive processor 338, transmit processor 320, TX MIMO processor 330, and/or controller/processor 340, as described with respect to FIG. 3. The one or more processors 1020 are coupled to a computer-readable medium/memory 1030 via a bus 1006. In certain aspects, the computer-readable medium/memory 1030 is configured to store instructions (e.g., computer-executable code) that when executed by the one or more processors 1020, cause the one or more processors 1020 to perform the method 700 described with respect to FIG. 7, or any aspect related to it. Note that reference to a processor of communications device 1000 performing a function may include one or more processors of communications device 1000 performing that function.

In the depicted example, the computer-readable medium/memory 1030 stores code (e.g., executable instructions) for receiving 1031 and code for transmitting 1032. Processing of the code 1031-1032 may cause the communications device 1000 to perform the method 700 described with respect to FIG. 7, or any aspect related to it.

The one or more processors 1020 include circuitry configured to implement (e.g., execute) the code stored in the computer-readable medium/memory 1030, including circuitry for receiving 1021 and circuitry for transmitting 1022. Processing with circuitry 1021-1022 may cause the communications device 1000 to perform the method 700 as described with respect to FIG. 7, or any aspect related to it.

Various components of the communications device 1000 may provide means for performing the method 700 as described with respect to FIG. 7, or any aspect related to it. Means for transmitting, sending or outputting for transmission may include the transceivers 332 and/or antenna(s) 334 of the BS 102 illustrated in FIG. 3 and/or transceiver 1008 and antenna 1010 of the communications device 1000 in FIG. 10. Means for receiving or obtaining may include the transceivers 332 and/or antenna(s) 334 of the BS 102 illustrated in FIG. 3 and/or transceiver 1008 and antenna 1010 of the communications device 1000 in FIG. 10.

### Example Clauses

Implementation examples are described in the following numbered clauses:

Clause 1: A method for wireless communication by a user equipment (UE), comprising: transmitting capability information indicating whether the UE needs time gaps between transmission segments associated with uplink signals to be transmitted by the UE in a non-terrestrial network (NTN); obtaining, based at least in part on the capability information, configuration information configuring the time gaps between the transmission segments associated with the uplink signals to be transmitted by the UE; and transmitting the uplink signals in one or more transmission segments based on the configuration information.

Clause 2: The method of Clause 1, wherein obtaining the configuration information comprises receiving the configuration information from a network entity in the NTN in response to transmitting the capability information to the network entity.

Clause 3: The method of Clause 1, wherein the configuration information is preconfigured in the UE based on a standards document.

Clause 4: The method of any of Clauses 1-3, wherein the time gaps are configured by the configuration information for the uplink signals transmitted via one or more first channels and are not configured for the uplink signals transmitted via one or more second channels.

Clause 5: The method of Clause 4, wherein the one or more first channels comprise at least a physical uplink shared channel (PUSCH) and the one or more second channels comprise at least a physical random access channel (PRACH).

Clause 6: The method of any of Clauses 1-5, wherein the capability information indicates one or more channels for which the time gaps are needed.

Clause 7: The method of any of Clauses 1-6, wherein the time gaps are configured by the configuration information for the uplink signals to be transmitted during a first connection state of the UE and are not configured for the uplink signals to be transmitted during a second connection state of the UE.

Clause 8: The method of Clause 7, wherein the first connection state comprises a radio resource control (RRC) connected state and the second connection state comprises a non-RRC connected state.

Clause 9: The method of any of Clauses 1-8, wherein the configuration information includes a duration for the time gaps between the transmission segments associated with the uplink signals to be transmitted by the UE.

Clause 10: The method of Clause 9, wherein the duration for the time gaps depends on a subcarrier spacing associated with the uplink signals.

Clause 11: The method of Clause 10, wherein: for a first subcarrier spacing, the duration for the time gaps comprises a first duration, and for a second subcarrier spacing that is less than the first subcarrier spacing, the duration for the time gaps comprises a second duration that is greater than the first duration.

Clause 12: The method of any of Clauses 1-11, wherein: a portion of the uplink signals are scheduled to be transmitted by the UE during a first time gap between a first transmission segment of the one or more transmission segments and a second transmission segment of the one or more transmission segments, and the method further comprises dropping transmission of the portion of the uplink signals scheduled to be transmitted during the first time gap.

Clause 13: The method of any of Clauses 1-11, wherein no portion of the uplink signals are scheduled for transmission within any time gap between any transmission segments of the one or more transmission segments.

Clause 14: The method of any of Clauses 1-13, wherein the time gaps are configured by the configuration information by default for the uplink signals transmitted by the UE via one or more default channels during a random access procedure regardless of the capability information indicating whether the UE needs the time gaps between the transmission segments.

Clause 15: The method of Clause 14, wherein: the one or more default channels comprise a physical random access channel (PRACH) and a physical uplink shared channel (PUSCH), and the uplink signals include at least one of a message to be transmitted on the PRACH during the random access procedure or a message to be transmitted on the PUSCH during the random access procedure.

Clause 16: The method of any of Clauses 14-15, wherein: the capability information indicates the UE does not need the time gaps between the transmission segments associated with uplink signals to be transmitted by the UE, and based on the indication that the UE does not need the time gaps, the configuration information does not configure the UE with the time gaps for channels other than the default channels.

Clause 17: The method of any of Clauses 1-16, wherein the uplink signals are associated with a narrowband internet of things (NB-IoT) service in the NTN or an enhanced machine type communication (eMTC) service in the NTN.

Clause 18: The method of any of Clauses 1-17, wherein transmitting the uplink signals in the one or more transmission segments comprises: compensating for a first propagation delay and a first frequency shift for a first set of uplink signals of the uplink signals to be transmitted in a first transmission segment of the one or more transmission segments; and compensating for a second propagation delay and second frequency shift for a second set of uplink signals of the uplink signals to be transmitted in a second transmission segment of the one or more transmission segments, to a second frequency account for the second propagation delay and second frequency shift.

Clause 19: A method for wireless communication by a network entity, comprising: receiving capability information from a user equipment (UE) indicating whether the UE needs time gaps between transmission segments associated with uplink signals to be transmitted by the UE in a non-terrestrial network (NTN); transmitting, based on the capability information, configuration information to the UE configuring the time gaps between the transmission segments associated with the uplink signals to be transmitted by the UE; and receiving the uplink signals in one or more transmission segments based on the configuration information.

Clause 20: The method of Clause 19, wherein the time gaps are configured by the configuration information for the uplink signals transmitted via one or more first channels and are not configured for the uplink signals transmitted via one or more second channels.

Clause 21: The method of Clause 20, wherein the one or more first channels comprise at least a physical uplink shared channel (PUSCH) and the one or more second channels comprise at least a physical random access channel (PRACH).

Clause 22: The method of any of Clauses 19-21, wherein the capability information indicates one or more channels for which the time gaps are needed.

Clause 23: The method of any of Clauses 19-22, wherein the time gaps are configured by the configuration information for the uplink signals to be transmitted during a first connection state of the UE and are not configured for the uplink signals to be transmitted during a second connection state of the UE.

Clause 24: The method of Clause 23, wherein the first connection state comprises a radio resource control (RRC) connected state and the second connection state comprises a non-RRC connected state.

Clause 25: The method of any of Clauses 19-24, wherein the configuration information includes a duration for the time gaps between the transmission segments associated with the uplink signals to be transmitted by the UE.

Clause 26: The method of Clause 25, wherein the duration for the time gaps depends on a subcarrier spacing associated with the uplink signals.

Clause 27: The method of Clause 26, wherein: for a first subcarrier spacing, the duration for the time gaps comprises a first duration, and for a second subcarrier spacing that is less than the first subcarrier spacing, the duration for the time gaps comprises a second duration that is greater than the first duration.

Clause 28: The method of any of Clauses 19-27, wherein: a portion of the uplink signals are scheduled to be transmitted by the UE during a first time gap between a first transmission segment of the one or more transmission segments and a second transmission segment of the one or more transmission segments, and the method further comprises not receiving the portion of the uplink signals scheduled to be transmitted during the first time gap.

Clause 29: The method of any of Clauses 19-27, wherein no portion of the uplink signals are scheduled for transmission within any time gap between any transmission segments of the one or more transmission segments.

Clause 30: The method of any of Clauses 19-29, wherein the time gaps are configured by default for the uplink signals transmitted by the UE via one or more default channels during a random access procedure regardless of the capability information indicating whether the UE needs the time gaps between the transmission segments.

Clause 31: The method of Clause 30, wherein: the one or more default channels comprise a physical random access channel (PRACH) and a physical uplink shared channel (PUSCH), and the uplink signals include at least one of a message to be transmitted on the PRACH during the random access procedure or a message to be transmitted on the PUSCH during the random access procedure.

Clause 32: The method of any of Clauses 19-31, wherein: the capability information indicates the UE does not need the time gaps between the transmission segments associated with uplink signals to be transmitted by the UE, and based on the indication that the UE does not need the time gaps, the configuration information does not configure the UE with the time gaps for channels other than the default channels.

Clause 33: The method of any of Clauses 19-32, wherein the uplink signals are associated with a narrowband internet of things (NB-IoT) service in the NTN or an enhanced machine type communication (eMTC) service in the NTN.

Clause 34: An apparatus, comprising: a memory comprising executable instructions; and one or more processors configured to execute the executable instructions and cause the apparatus to perform a method in accordance with any one of Clauses 1-33.

Clause 35: An apparatus, comprising means for performing a method in accordance with any one of Clauses 1-33.

Clause 36: A non-transitory computer-readable medium comprising executable instructions that, when executed by one or more processors of an apparatus, cause the apparatus to perform a method in accordance with any one of Clauses 1-33.

Clause 37: A computer program product embodied on a computer-readable storage medium comprising code for performing a method in accordance with any one of Clauses 1-33.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. §112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A user equipment (UE), comprising:
a memory comprising executable instructions; and
one or more processors configured to execute the executable instructions and cause the UE to:
transmit capability information indicating whether the UE needs time gaps between transmission segments associated with uplink signals to be transmitted by the UE in a non-terrestrial network (NTN);
obtain, based at least in part on the capability information, configuration information configuring the time gaps between the transmission segments associated with the uplink signals to be transmitted by the UE; and
transmit the uplink signals in one or more transmission segments based on the configuration information.

2. The UE of claim 1, wherein, in order to obtain the configuration information, the one or more processors are configured to cause the UE to receive the configuration information from a network entity in the NTN in response to transmitting the capability information to the network entity.

3. The UE of claim 1, wherein the configuration information is preconfigured in the UE based on a standards document.

4. The UE of claim 1, wherein the time gaps are configured by the configuration information for the uplink signals transmitted via one or more first channels and are not configured for the uplink signals transmitted via one or more second channels.

5. The UE of claim 4, wherein the one or more first channels comprise at least a physical uplink shared channel (PUSCH) and the one or more second channels comprise at least a physical random access channel (PRACH).

6. The UE of claim 1, wherein the capability information indicates one or more channels for which the time gaps are needed.

7. The UE of claim 1, wherein the time gaps are configured by the configuration information for the uplink signals to be transmitted during a first connection state of the UE and are not configured for the uplink signals to be transmitted during a second connection state of the UE.

8. The UE of claim 7, wherein the first connection state comprises a radio resource control (RRC) connected state and the second connection state comprises a non-RRC connected state.

9. The UE of claim 1, wherein the configuration information includes a duration for the time gaps between the transmission segments associated with the uplink signals to be transmitted by the UE.

10. The UE of claim 9, wherein the duration for the time gaps depends on a subcarrier spacing associated with the uplink signals.

11. The UE of claim 10, wherein:
for a first subcarrier spacing, the duration for the time gaps comprises a first duration, and
for a second subcarrier spacing that is less than the first subcarrier spacing, the duration for the time gaps comprises a second duration that is greater than the first duration.

12. The UE of claim 1, wherein:
a portion of the uplink signals are scheduled to be transmitted by the UE during a first time gap between a first transmission segment of the one or more transmission segments and a second transmission segment of the one or more transmission segments, and
the one or more processors are further configured to cause the UE to drop transmission of the portion of the uplink signals scheduled to be transmitted during the first time gap.

13. The UE of claim 1, wherein no portion of the uplink signals are scheduled for transmission within any time gap between any transmission segments of the one or more transmission segments.

14. The UE of claim 1, wherein the time gaps are configured by the configuration information by default for the uplink signals transmitted by the UE via one or more default channels during a random access procedure regardless of the capability information indicating whether the UE needs the time gaps between the transmission segments.

15. The UE of claim 14, wherein:
the one or more default channels comprise a physical random access channel (PRACH) and a physical uplink shared channel (PUSCH), and
the uplink signals include at least one of a message to be transmitted on the PRACH during the random access procedure or a message to be transmitted on the PUSCH during the random access procedure.

16. The UE of claim 14, wherein:
the capability information indicates the UE does not need the time gaps between the transmission segments associated with uplink signals to be transmitted by the UE, and
based on the indication that the UE does not need the time gaps, the configuration information does not configure the UE with the time gaps for channels other than the default channels.

17. The UE of claim 1, wherein the uplink signals are associated with a narrowband internet of things (NB-IoT) service in the NTN or an enhanced machine type communication (eMTC) service in the NTN.

18. The UE of claim 1, wherein, in order to transmit the uplink signals in the one or more transmission segments, the one or more processors are configured to cause the UE to:
compensate for a first propagation delay and a first frequency shift for a first set of uplink signals of the uplink signals to be transmitted in a first transmission segment of the one or more transmission segments; and
compensate for a second propagation delay and second frequency shift for a second set of uplink signals of the uplink signals to be transmitted in a second transmission segment of the one or more transmission segments, to a second frequency account for the second propagation delay and second frequency shift.

19. A network entity, comprising:
a memory comprising executable instructions; and
one or more processors configured to execute the executable instructions and cause the network entity to:
receive capability information from a user equipment (UE) indicating whether the UE needs time gaps between transmission segments associated with uplink signals to be transmitted by the UE in a non-terrestrial network (NTN);
transmit, based on the capability information, configuration information to the UE configuring the time gaps between the transmission segments associated with the uplink signals to be transmitted by the UE; and
receive the uplink signals in one or more transmission segments based on the configuration information.

20. The network entity of claim 19, wherein:
the time gaps are configured by the configuration information for the uplink signals transmitted via one or more first channels and are not configured for the uplink signals transmitted via one or more second channels, and
the one or more first channels comprise at least a physical uplink shared channel (PUSCH) and the one or more second channels comprise at least a physical random access channel (PRACH).

21. The network entity of claim 19, wherein the capability information indicates one or more channels for which the time gaps are needed.

22. The network entity of claim 19, wherein:
the time gaps are configured by the configuration information for the uplink signals to be transmitted during a first connection state of the UE and are not configured for the uplink signals to be transmitted during a second connection state of the UE; and
the first connection state comprises a radio resource control (RRC) connected state and the second connection state comprises a non-RRC connected state.

23. The network entity of claim 19, wherein:
the configuration information includes a duration for the time gaps between the transmission segments associated with the uplink signals to be transmitted by the UE,
the duration for the time gaps depends on a subcarrier spacing associated with the uplink signals,
for a first subcarrier spacing, the duration for the time gaps comprises a first duration, and
for a second subcarrier spacing that is less than the first subcarrier spacing, the duration for the time gaps comprises a second duration that is greater than the first duration.

24. The network entity of claim 19, wherein:
a portion of the uplink signals are scheduled to be transmitted by the UE during a first time gap between a first transmission segment of the one or more transmission segments and a second transmission segment of the one or more transmission segments, and
the one or more processors are further configured to cause the network entity to not receive the portion of the uplink signals scheduled to be transmitted during the first time gap.

25. The network entity of claim 19, wherein no portion of the uplink signals are scheduled for transmission within any time gap between any transmission segments of the one or more transmission segments.

26. The network entity of claim 19, wherein:
the time gaps are configured by default for the uplink signals transmitted by the UE via one or more default channels during a random access procedure regardless of the capability information indicating whether the UE needs the time gaps between the transmission segments,
the one or more default channels comprise a physical random access channel (PRACH) and a physical uplink shared channel (PUSCH), and
the uplink signals include at least one of a message to be transmitted on the PRACH during the random access procedure or a message to be transmitted on the PUSCH during the random access procedure.

27. The network entity of claim 26, wherein:
the capability information indicates the UE does not need the time gaps between the transmission segments associated with uplink signals to be transmitted by the UE, and
based on the indication that the UE does not need the time gaps, the configuration information does not configure the UE with the time gaps for channels other than the default channels.

28. The network entity of claim 19, wherein the uplink signals are associated with a narrowband internet of things (NB-IoT) service in the NTN or an enhanced machine type communication (eMTC) service in the NTN.

29. A method for wireless communication by a user equipment (UE), comprising:
transmitting capability information indicating whether the UE needs time gaps between transmission segments associated with uplink signals to be transmitted by the UE in a non-terrestrial network (NTN);
obtaining, based at least in part on the capability information, configuration information configuring the time gaps between the transmission segments associated with the uplink signals to be transmitted by the UE; and
transmitting the uplink signals in one or more transmission segments based on the configuration information.

30. A method for wireless communication by a network entity, comprising:
receiving capability information from a user equipment (UE) indicating whether the UE needs time gaps between transmission segments associated with uplink signals to be transmitted by the UE in a non-terrestrial network (NTN);
transmitting, based on the capability information, configuration information to the UE configuring the time gaps between the transmission segments associated with the uplink signals to be transmitted by the UE; and
receiving the uplink signals in one or more transmission segments based on the configuration information.
